(19) United States
(12) Patent Application Publication
(10) Pub. No.: US 2004/0080528 A1
(43) Pub. Date: Apr. 29, 2004

(54) Systems and methods for presenting interactive programs over the internet

(75) Inventors: Alan Rand, Richmond, VA (US); Robert Kuhn, Pelham, NY (US); Peter Cardillo, Huntington, NY (US); Marco M. Bianco, San Francisco, CA (US)

Correspondence Address: Steven Moses, WATCHIT.COM, 6851 Jericho Turnpike, Syosset, NY, 11791, US

(73) Assignee: WATCHIT.COM,INC.

(21) Appl. No.: 09/836,155

(22) Filed: Apr. 16, 2001

Related U.S. Application Data
(60) Provisional application No. 60/258,102, filed on Dec. 22, 2000.
(60) Provisional application No. 60/212,974, filed on Jun. 21, 2000.

(51) Int. Cl. G09G 5/00

(52) U.S. Cl. 345/738

(57) ABSTRACT

Systems and methods for presenting programs over the Internet to a user's computer are disclosed. The programs include video and text corresponding to the video, wherein the text is preferably advanced page by page, in synchronization with the video. Preferably, access is provided to additional information, including web pages stored by servers external to the organization, information stored in the organization's system and information served to the user's computer. The information is accessible through activation points in the text and elsewhere on a graphical user interface, which directly access the information or which directs the user to other activation points for accessing the information. The accessible information or references to the accessible information is served to the user's computer prior to presentation of the program.

### RELATED APPLICATIONS

The present application claims the benefit of U.S. Ser. No. 60/258,102, filed on Dec. 22, 2000 and U.S. Ser. No. 60/212,974, filed on Jun. 21, 2000, which are assigned to the assignee of the present invention and are incorporated by reference, herein.

### FIELD OF THE INVENTION

The present invention relates to video programs presented via the Internet and more particularly, to programs including video, text of the video and the ability to access additional information related to the program.

### BACKGROUND OF THE INVENTION

Globalization, increased competition and the dependence on rapidly developing technologies has made the continuing education of corporate employees a priority. Continuing education programs for professionals, such as doctors, lawyers and accountants, have also been growing as professionals seek to keep abreast of new developments in their fields and regulatory and accreditation organizations increase their requirements.

Live presentations have commonly been used to provide continuing education programs. In live presentations, however, an individual cannot control the speed of presentation. Whether the viewer does not understand a particular topic of the presentation or does not need exposure to a particular topic, the viewer must listen to the entire presentation, delivered at the pace chosen by the presenter. The viewer is also limited to the content, including visual aids, selected by the presenter. Schedule and travel considerations limit the effective reach of live presentations, as well.

Live presentations have been videotaped and audiotaped to allow for more flexibility for individual or group use. Individual viewing of videotapes and audiotapes also enables an individual to replay a section of the tape for further review and to fast forward through a section which is not needed. Like a live presentation, however, the viewer is limited to the content provided by the presenter. In addition, audiotapes do not readily allow for the use of visual aids.

The development of the CD-ROM enabled significant enhancements to live and videotaped presentations. Because of the digital nature of the video presentation stored on the CD-ROM, the user can navigate to any desired location in the presentation through a graphical user interface (“GUI”). The program is thereby made interactive and placed under the control of the user. The memory provided on the CD-ROM enables a transcript of the presentation to be displayed with the video presentation on the GUI. The text is typically scrolled as the video advances. Text may be provided below the video. The text may be scrolled as the video is advanced. The text may also be searched by keywords.

Interactivity has been further enhanced by providing access to other information through the CD-ROM for display, as well. For example, slides have been provided on the GUI to supplement the video presentation. Selective access to documents relevant to the presentation has also been provided. An outline or list of topics of the presentation, definitions of terms and Web links to other relevant information have been provided, as well.

Accommodating the video, the transcript, additional information, such as slides, and activation points to further information on a GUI in an efficient manner has been challenging. As additional information is provided with the video and transcript, the regions for display of the video and transcript must shrink, making them harder to view and read. Attempts to display the available information and/or the activation points to the information have resulted in cluttered interfaces. In addition, scrolling text may be hard to read and distracting to a viewer watching the video. CD-ROM based presentations that seek to take advantage of the vast amount of accessible information may not, therefore, provide a pleasant user experience conducive to learning. In addition, the CD-ROMS themselves must be stored. A significant amount of space may be required by an organization or an individual to maintain a library of CD-ROMs. Use of a CD-ROM also requires that a CD-Player be connected to the computer.

WatchIT.com, Inc., Syosset, N.Y., produces CD-ROM presentations wherein the text is advanced page by page, in synchronization with the video. In one version, the GUI includes a text region adjacent to a video region. The text extends from the bottom to the top the GUI, across half the width of the GUI. The video extends from the bottom of the screen to a small, compact region containing activation points to additional information, above the video screen. The video region is only slightly reduced in size to accommodate the activation points. Upon selection of an activation point, additional information may be accessed. Selected information is superimposed over the video presentation.

The proliferation of the Internet has greatly expanded the information accessible to an individual through a computer. While the use of video from the Internet was originally limited due to the need to download large amounts of data, the development of streaming media technologies has facilitated the downloading and display of video and audio files by computers from the Internet, enabling the almost immediate playback of continuous “streams” of video and audio content. A new dimension was added to the Internet experience.

Use of the Internet for interactive programs presents technical problems, however. Once information, such as a web page, is received by a computer from a server on the Internet, the connection with the server is typically broken. A connection needs to be maintained with a server streaming video, however. Since requests for additional information typically require a browser to establish a new connection to an appropriate server, requests for information from a server made while within a browser window playing a video causes interruption of the video. It could take a minute or more for the requested information to be returned, a new browser window opened and the video started at the proper location. Such interruptions could interfere with the smooth presentation of a program, breaking the concentration of the user. This would be particularly distracting during an educational program.

### SUMMARY OF THE INVENTION

The present invention enables the presentation of programs through the Internet with a high degree of user interactivity, in an efficient manner which does not distract the user.

In one aspect of the invention, the presentation of programs comprising video and text, by an organization through the Internet, is made more conducive by displaying the text page by page, in synchronization with the video. Preferably, the video and the text are displayed adjacent to each other. Additional information may be selectively accessed by the user during display of the video and the text, including web pages stored by the organization, web pages stored by servers external to the organization and information downloaded to the user's computer prior to the start of the program.

In another aspect of the invention, client side scripting, such as JavaScript functions, is provided to the user's computer prior to display of the video and text, to enable functions to be performed by the computer. The program may continue while the processing by the computer takes place and responses to selections of certain activation points may be provided very rapidly.

In another aspect of the invention, a graphical user interface is disclosed comprising a first region for displaying video of a presentation, a second region for displaying text corresponding to the video and a third region comprising a display portion for selectively displaying at least one additional function. The third region also comprises an activation point. Activation of the activation point causes display of the at least one function in the display portion. The function is hidden until the activation point is activated. The display portion is a substantial part, preferably at least about 80%, of the third region. Functions may be selected and certain information displayed in the third display portion, while the video and text are being viewed. The functions preferably include a topics list of the program, a glossary of terms used in the program, keyword searching, web links relevant to the program, information about the presenter of the program and participants in the program and other information relevant to the program. The information may be stored by the organization, stored on servers on the Internet not part of the organization and served to the user's computer for storage prior to display of the video and the text. Since the function is hidden until selected, the user may view just the video and the text until additional information is desired. The user is not, therefore, distracted by a cluttered, graphical user interface.

The present invention is particularly suited for enhancing the value of instructional presentations as a learning aid, but many of the interactive features may be applicable to any type of Internet based presentation or program.

### BRIEF DESCRIPTION OF THE FIGURES

FIG. 1 is a view of a Graphical User Interface (“GUI”) in accordance with one embodiment of the present invention;

FIG. 2 is a view of a Topics Layer of the GUI of FIG. 1;

FIG. 3 is a view of a Search Layer of the GUI of FIG. 1;

FIG. 4 is a view of a Glossary Layer of the GUI of FIG. 1;

FIG. 5 is a view of Web Links Layer of the GUI of FIG. 1;

FIG. 6 is a view of a Presenter Layer of the GUI of FIG. 1;

FIG. 7 is a view of a Resources Layer of the GUI of FIG. 1; and

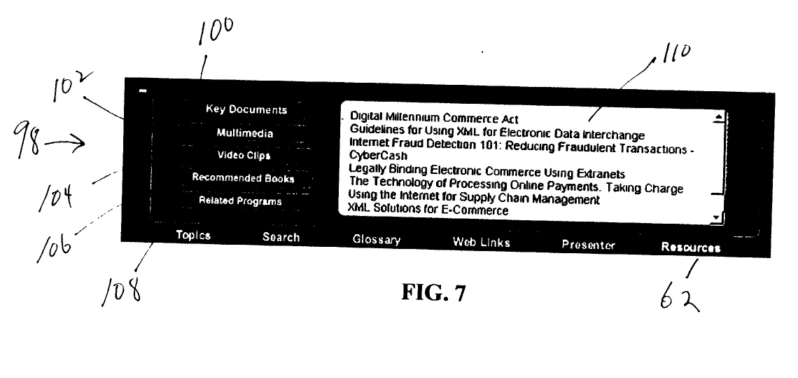

FIG. 8 is a view of a system in accordance with the present invention.

### DETAILED DESCRIPTION OF THE INVENTION

Interactive programs comprising video and text of the video are presented through the Internet in accordance with the present invention, on a monitor screen of a user's computer. The text of the program is preferably presented alongside the video presentation on the computer screen. The video program and the text may be advanced, reversed or paused, at the user's discretion. Preferably, the text advances page by page in coordination with the video. Presenting the text adjacent to the video and the advancement of the text page by page are believed to be more conducive to the user's reading of the text during presentation of the program than stacking the video and text and scrolling the text, which has been typically used in the prior art.

While the video will typically include spoken words and the text will be a text of the spoken words, alternative formats may be used. For example, the video may be of a musical performance and the text may be the score of the performance and/or commentary on the performance. The video presentation may be in one language and the text may be a translation of the presentation into another language. There may be an option to switch between text of the presentation in the language of the video and a translation of the text.

In addition to the video and text of the presentation, additional information is preferably accessible to the user. Activation points such as hyperlinks to web pages or other sources of relevant information are preferably provided in the transcript and/or at other locations on the screen. Such information, referred to as “resources”, may include relevant HTTP, HTTPS and FTP web pages, articles from journals, magazines, newspapers and web sites, reports and research papers by scholars, academic institutions, consultants and citizen groups, for example. If the subject matter of the program is technical, descriptions of products, systems, processes and services by manufacturers and vendors may also be provided. Transcripts and other information from related programs provided by the organization, resumes of the presenter and others knowledgeable in the field, recommended books related to the topic of the presentation with links to on-line bookstores such as Amazon.com, and any other type of relevant information may also be made accessible. Multimedia programs, such as PowerPoint presentations, graphical images and video clips are also preferably accessible through the activation points.

Access to on-screen demos, which are separate executable files of a portion of the program, are also preferably provided. For example, the presenter may perform an activity during the presentation, which may be difficult to view on the video presentation. While the presenter is performing the operation, a suitable program, such as Lotus Screen Cam, can be used to capture the demonstration, for separate presentation with higher resolution than the video presentation.

A glossary of terms used in the presentation may also be prepared by the organization and readily made accessible to the user through an activation point such as a hyperlink, for example. The ability to look up definitions of terms relevant to the program during presentation of the program may be very helpful to a user. A list of topics of the program is also preferably provided.

The information may be stored on the web server or servers of the organization providing the program and/or on web servers of external organizations. Certain information is preferably served to the user's computer prior to presentation of the program. For example, the glossary and topics list are preferably served to the user's computer, for speed of access.

These additional resources assist the user in learning the subject matter of the presentation, as well as to go beyond the subject matter of the presentation.

Other enhancements to the program include Pre-Tests for evaluating the level of the user's knowledge prior to the presentation and Post-Tests to evaluate the level of understanding of the user after the program. Such tests may be taken and evaluated on-line. Tests may be provided during the program, as well.

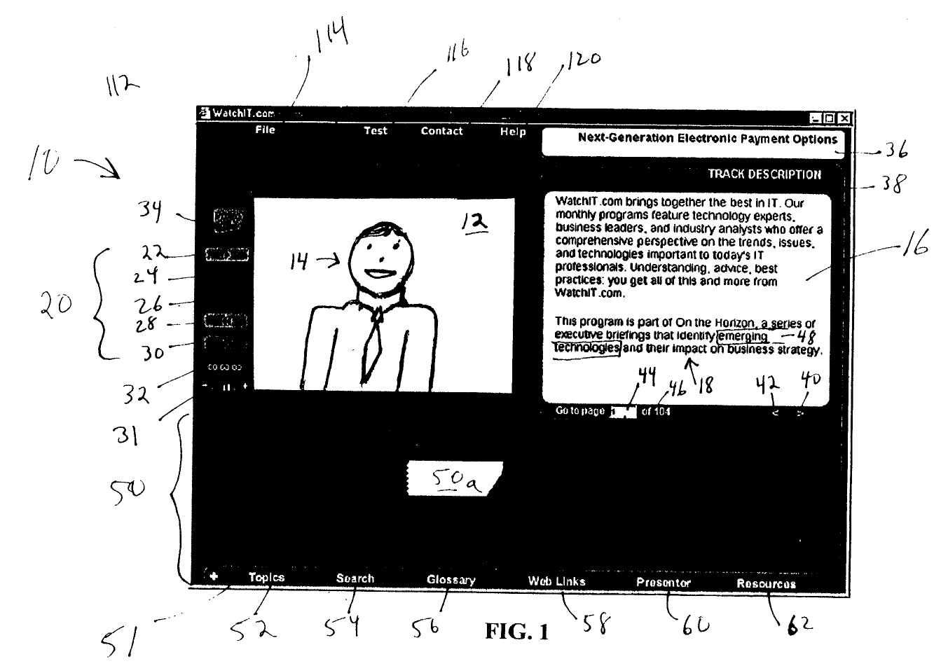

Preferably, the program is presented to the user through a graphical user interface (“GUI”) with the organization's resources. FIG. 1 is an example of a GUI 10 in accordance with a preferred embodiment of the present invention, as it would appear on the monitor screen of a user's computer. The GUI comprises elements, such as graphics and regions positioned by HTML and Cascading Style Sheets (CSS), as is known in the art. The code defining the GUI contains client side scripting, such as JavaScript functions, for controlling the functionality of the GUI 10. A Video Region 12 is provided for presentation of a video of the program, which may include a speaker 14, for example, and a Transcript Text Region 16 is provided for an accompanying transcript of the text 18 of the speaker's presentation. The GUI 10 preferably uses Windows style menu commands.

The transcript is displayed in the Transcript Text Region 16 in synchronization with the video. The text 18 preferably advances page by page as the speaker's presentation advances. Fourteen lines per page has been found to be an optimal arrangement for reading by a user during presentation of the program. The Video Region 12 and the Transcript Text Region 16 preferably each have an Aspect Ratio of at least about 320×240 pixels in an 800×600 pixel screen size, for ease of viewing and reading.

The Video Region 12 includes Video Control Tabs 20 such as Play 22, Pause 24, Stop 26, Reverse 28 and Forward 30. A Volume Tab 31 is also preferably provided. These and other tabs and activation points may be activated by clicking a button of a mouse or by the use of other such input devices. Some of the Video Control Tabs 20 could also be arranged to be controlled by dragging a cursor across the Tab.

Preferably, each video control has On/Off mouseover images (not shown), which toggle between symbols and a text description of the symbols. Also, the color shade of the buttons may be varied to indicate the current state and availability of that function, depending upon which function is selected.

A Video Clock 32 displays the elapsed time of the video. A mouseover image may be used to display the total run time.

A Video Only Tab 34 is provided to cause display of the video in a full screen mode.

Clicking on the Forward Tab 30 preferably advances the video and the transcript text to the location corresponding to the next page of displayed text. Clicking on the Rewind Tab 28 preferably returns the video to the location corresponding to the top of the current page of text or to the prior page of text, depending on when it is activated. For example, if the Rewind Tab 28 is activated within a predetermined time period, such as two seconds, after the start of the current page of text, the video will be returned to the location corresponding to the top of the prior page of text. If the Rewind Tab is activated more than two seconds after the start of the current page of text, the video will be returned to the location corresponding to the top of the current page. The term “advance” may refer to forward or reverse movement of the pages of text and the video.

Above the Transcript Text Region 16 is a Title Display Region 36, showing the title of the program. In FIG. 1, the title is “Next-Generation Electronic Payment Options”. The Transcript Text Region 16 also includes a Topic Display Section 38 as part of its graphics, showing the topic or subtopic of that portion of the transcript and video. In FIG. 1, the topic is “Track Description”.

A Forward Page Tab 40 and a Back Page Tab 42 are provided to advance or return the transcript one page.

A Transcript Text Page Display 44 displays the present page number of the transcript and the total number of text 18 to that page. The total number 46 of pages is displayed next to the Display 44. The Display 44 is also a Go To Page entry field, which enables the user to enter a page number to advance or return the text 18 to that particular page, by pressing the Enter button on a keyboard. The video preferably advances or reverses to that page, as well.

A preferred system and method for accomplishing these functions is also described further, below.

The text 18 of the transcript preferably includes activation points, such as highlighted hyperlinks 48, to additional resources available to the user, as discussed above.

A Functions Region 50 including additional activation points is also preferably provided at the bottom of the screen to enable the user to further interact with the presentation to obtain access to additional resources. Access to resources available though the activation points in the transcript text may also be obtained. Until a function is activated, the Functions Region displays only a Functions Bar 51 so that a user only views the video and text. The user is not, therefore, distracted by additional information on the GUI 10, until such information is desired.

In this embodiment, six activation points are provided on the Functions Bar 51: 1) a Topics Tab 52; 2) a Search Tab 54; 3) a Glossary Tab 56; 4) a Web Links Tab 58; 5) a Presenter Tab 60; and 6) a Resources Tab 62. Clicking one of the Function Tabs fills the Functions Region 50 with a layer of information and graphics which may include further activation points. By providing multiple levels of activation points, the appearance of the GUI 10 remains uncluttered. By restricting the Functions Region 50 to the area below the Video Region 12 and the Transcript Region 16, the program may continue to be presented, even after a Functions Tab is activated.

As discussed above, to provide the desired amount of additional information, prior art Internet presentation programs have included multiple permanently opened windows or regions for accessing or displaying information, in addition to a video region and a transcript text region. The display of so much information may distract the user. It has also been necessary in the prior art to reduce the size of the video and transcript regions to accommodate the additional information, making viewing of the program and reading of the transcript, difficult.

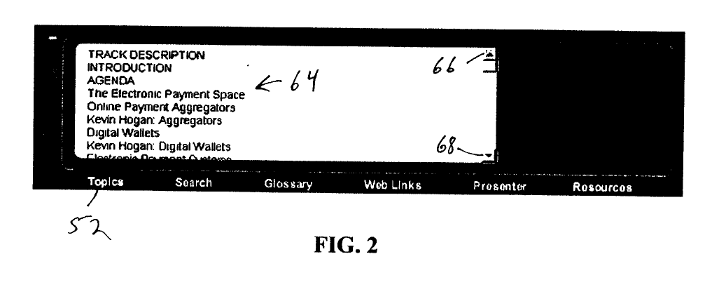

Clicking on the Topics Tab 52 displays a Topics List 64 of the topics of the program, as shown in FIG. 2. The List 64 is advanceable if need be, by up and down arrows 66, 68, respectively. Clicking on a particular topic advances the video and the transcript to the portion of the presentation dealing with that topic. Topics which have already been viewed may be “grayed out” to a light blue color, for example.

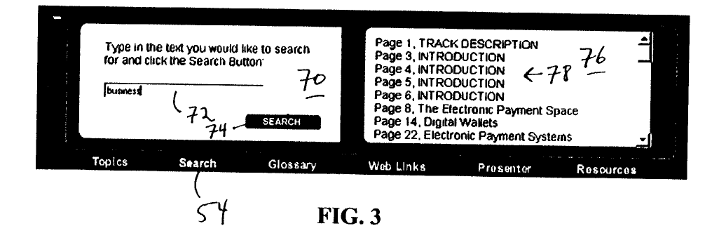

The Search function enables searching of the transcript for a text string of one or more words entered by the user. Clicking on the Search Tab 54 displays a Search Region 70 comprising a left portion including a field 72 for entry of a word or phrase and a SEARCH Tab 74, as shown in FIG. 3. Search results are displayed in a right portion 76 of the Search Region. Activating the SEARCH Tab 74 after entry of a word or phrase generates a list 78 of pages in the right portion where the word or phrase appears, along with the topic of the page. The user can click on any entry in the list 78 to advance the transcript text and the video forward or back to that page. The first occurrence of the search text string in the transcript page is preferably highlighted.

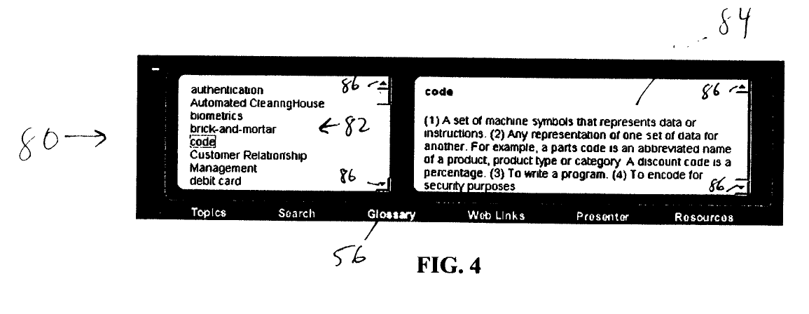

The Glossary function provides access to the definitions of certain terms used in the program. Clicking on the Glossary Tab 56 displays a Glossary Region 80 including a list 82 of defined terms and Definition Section 84 as shown in FIG. 4. The list may be advanced to the desired term. Clicking on the desired term causes display of the definition in the Definition Section. Alternatively, or in addition, a search window (not shown) may be provided to search for definitions of particular terms. When a glossary term hyperlink is clicked from the text in the Transcript Text Box, the Glossary Region is displayed, including the definition of the highlighted term. Arrows 86 enable the movement of the list or definition.

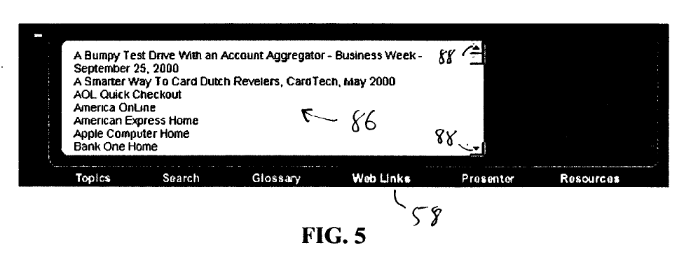

Clicking on the Web Links Tab 58 displays a list 86 of activation points or links to external web pages, as shown in FIG. 5. Clicking on one of the activation points causes a browser to open a window for display of the requested web page, as described further, below. Arrows 88 enable the movement of the list.

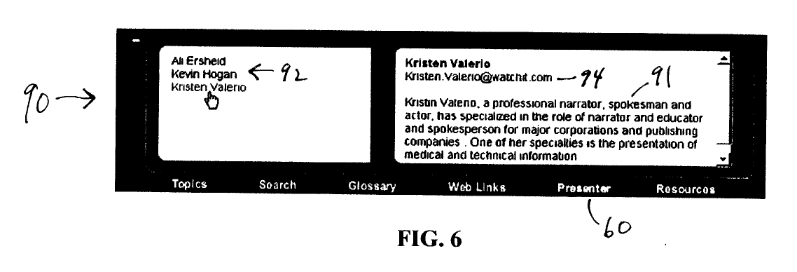

Clicking on the Presenter Tab displays a Presenter Region 90 including a left portion with a list 92 of the names of the presenter and any people interviewed during the program, as shown in FIG. 6. Each name is an activation point to further information about the person. Clicking on a name causes the display of information 91 in the right portion of the Region 90. An e-mail link 94 may be provided for contacting the presenter through the organization or directly. Arrows 96 enable the movement of the displayed information 91.

Clicking on the Resources Tab 62 provides links to resources stored by the organization (not external web pages) which are accessible by the user. Preferably, the resources are organized by categories. Clicking on the Resources Tab opens a Resources Region 98 with separate activation points for each of the general categories of the resources, as shown in FIG. 6. In the preferred embodiment, the categories are: 1) Key Documents 100; 2) Multimedia 102; 3) Video Clips 104; 4) Recommended Books 106; and 5) Related Programs 108. Other categories could be used instead of or in addition to those listed here. When one of these activation points is activated, a list 110 of the links to the available resources in that category is displayed in the right side of the Region 98. Clicking on one of the links causes retrieval of the resource. Clicking the Related Programs activation point 108 provides a list of links to web pages of other programs offered by the organization, which are related to the present program. Clicking on one of the links causes display of the web page for that program. Information about that program, such as a summary of the program and an identification of the presenter, appears on the home page. Links to selected resources also appears on the web page. The related program may be started from the web page in place of the original program.

Returning to FIG. 1, a menu bar 112 is also provided including File 114, Test 116, Contact 118, and Help 120 activation points. Clicking on File 114 opens a drop down menu (not shown) offering the viewing or printing of the transcript of the text and a workbook. Clicking on Contact 118 opens a drop down menu (not shown) offering a custom e-mail link directly to the organization and “Send Us Feedback” survey forms. These survey forms may be changed as the organization seeks end-user reaction to help evaluate new features and functionality that are under consideration or have recently been introduced.

Clicking on Test 116 opens a window providing a drop down menu (not shown) with activation points to further windows, including Pre-Tests and Post-Tests. The Pre-Tests may be a short, multiple choice test. Ten questions may be posed, for example. A Post-Test may also be selected to check the user's progress at any time during the program and after the program has been completed. The Pre-Test and Post-Test offer parallel review capabilities, allowing the user to see all of the questions in full and the answers selected by the user. The Post-Test review also reveals the correct answer. In addition, activation points to the page of the program dealing with any selected question, are preferably provided. Each test lets the user Save results, Print them immediately, or both. The Post-Test provides comparative results, if the Pre-Test was taken.

FIG. 9 is an example of a system 200 for providing interactive presentations through the Internet 202 in accordance with one embodiment of the invention. The system comprises a Database 204, a Web Server 200, an Application Server 208, a Resource Server 210 and a Video Server 212. A Web Link Checker 214 is also preferably provided. The Database, Application Server, Web Server, Resources Server, Video Server and Web Link Checker are typically maintained by the organization presenting the program, as indicated by the dotted line. A block 214 for External Servers is also shown, which represents servers storing relevant information which are not part of the system 200. The External Servers 214 are in communication with the Internet 202, including the World Wide Web and the File Transfer Network, which also store resources accessible to the user. Individual users at personal computers (“PCs”) 216 are also shown in communication with the Internet.

All requests from the user go to the Web Server 206. The Web Server stores text files containing Hypertext Markup Language (“HTML”), Cold Fusion Markup Language (“CFML”), Cascading Style Sheets (“CSS”) and JavaScript functions. For example, the GUI 10 is stored in the Web Server in the form of one or more text files including HTML, Dynamic HTML (“DHTML”), including JavaScript and CSS, and CFML. Separate text files are preferably provided to define the GUI 10 for use with different browsers, such as Internet Explorer and Netscape Navigator. Preferably, the GUI 10 for each browser has the same appearance. The GUI 10 to be used with Netscape Navigator is preferably defined in HTML by layer tags, DIV tags and other HTML tags. The GUI 10 to be used with Internet Explorer is preferably defined in HTML by DIV tags and other HTML tags. Specific functional layers of the GUI are thereby defined with respect to a Z-index. While frames could be used to define the GUI, use of frames could require more complicated programming and could adversely affect system stability and speed of interactivity.

The organization's home page and web pages for individual programs are also stored on the Web Server. Certain resources in the form of dynamic web sites are also preferably stored on the Web Server.

The Application Server 208 communicates with the Web Server 206 through a Common Gateway Interface (“CGI”), as is known in the art. The Database 204 and the Application Server 208 communicate directly with each other. The Resource Server 210, the Video Server 212 and the Web Link Checker 214 are in communication with the Internet, as well.

The Resource Server 210 stores other resources available to the user in an appropriate, static, file format. For example, documents may be stored in PDF files. Graphical images may be stored as JPEG or GIF files. Animated video may be stored as an MPEG file. Movies may be stored as Real Media (RM), AVI or QuickTime files. Music or sounds may be stored as Basic Sound, WAV, MIDI or Real Audio files. Preferably, all files of a particular file format (i.e., PDF, JPEG or GIF, for example) are stored in a respective folder in the Resource Server. The functions of the Resource Server 210 and the Web Server 206 may be performed by a single server or additional, separate servers, as is known in the art.

The Database 204 is preferably a relational Database that stores relevant information in a plurality of tables. For example, a table of transcript pages, corresponding beginning and end times for time segments of the video presentation and the topics of each page are preferably provided, as described further below. Tables of glossary terms and their definitions, presenter names and associated information, recommended books and purchase information, lists of related programs, addresses of external web pages and references to other resources such as documents, multimedia, video clips, are also preferably provided in tables in the Database. Preferably, each table stores corresponding data for all the programs offered by the organization.

In a preferred embodiment, synchronization between the video and text, and other functions, are provided by populating a table stored in the Database with the start and end times of the video segment corresponding to each page of the text. The table may have the following format:

TABLE I

| | Program | | | | | | Transcript |
|---|---|---|---|---|---|---|---|
| Course ID | Page | Cue Start | | Cue End | | Topic | Text |
| ABC | 50 | 3339.1 | sec | 34,600.5 | sec | Conclusion | |
| XYZ | 1 | 0 | sec. | 30.1 | sec. | Introduction | |
| XYZ | 2 | 30.1 | sec | 45.0 | sec | Introduction | |
| XYZ | 3 | 45.0 | sec | 82.2 | sec | Outline | |
| XYZ | 4 | 82.2 | sec | 130.9 | sec | A | |
| XYZ | 5 | 130.9 | sec. | 190.7 | sec. | B | |
| XYZ | • | • | | • | | • | • |
| XYZ | • | • | | • | | • | • |
| XYZ | 49 | 3101.5 | sec. | 3200.8 | sec. | • | • |
| EFG | 1 | 0 | sec | 15.1 | sec | Introduction | |

The Course ID is an identification of the program associated with the information along the same row. All the transcript pages, and other associated information for every program offered by the organization, may be stored in a single table. When a particular program is selected by the user, the appropriate table entries are retrieved from the Database and served to the user's computer, based on the Course ID of the selected program.

Cue Start is the starting time for a particular segment of video. Cue End is the end time for that segment. While the time entries include tenths of a second for illustrative purposes, hundredths of a second are preferred and thousandths of a second are more preferred, for better synchronization with the video. It is noted that the length of the video corresponding to each page of transcript is typically not constant. Columns are preferably provided listing the topic of each video segment and the complete transcript of the text corresponding to the video segment between the Cue Start and Cue End times. A Transcript Page column identifies the page number of the Transcript Text corresponding to the video segment.

In addition, the Database stores one or more tables containing additional information related to each of the resources available to the user. For example the Database may store the address (URL) of a web page or the file type and file name of the resource, indicating the location of a document stored on the Resource Server 210 or the Web Server 206.

In the preferred embodiment, each resource is uniquely identified in the Database 204 by a number, referred to as a Resource ID. It has been found useful to associate with the Resource ID an identification of the Resource Type, which, for a resource stored in the Resource Server 210 or the Web Server 206, is typically the type of file format in which the resource is stored (i.e., PDF, JPEG or GIF, for example). If the resource is stored on the Database 204, the Resource Type points to an appropriate table of information. The association between Resource ID and Resource Type is provided in a table referred to as a Resource Information table. The Resource Type points to the folder in the Resource Server 210 or Web Server 206 where files of that type are stored. A classification of the resource as a glossary term, web link, presenter information, key document, multi-media, video clips, recommended books or related program is also associated with the Resource ID in this or another table, to facilitate creation of the appropriate resource lists for display by the GUI 10, as discussed further, below.

Another table, referred to as a Resource URL Table, is preferably provided to associate the Resource ID with the file name on the Resource Server 210 or Web Server 206 or the external web address (URL) where the resource may be found.

Also preferably associated with the Resource ID in the Resources Information Table is an indication of the availability of the resource, referred to as the Status ID. This is particularly useful for web pages that may go down, as discussed further, below.

Preferably, a reference to the Resource ID is also provided, referred to as a Pointer ID. The Pointer IDs are served from the Web Server 206 to the user's PC 216, along with JavaScript functions for passing the respective Pointer ID for a selected resource to the Application Server 208 when an activation point for that resource is activated. The Pointer ID is preferably associated with the Resource ID in another table, referred to as a Resource Link Table. Preferably, a Link Name, which is a English word or phrase identifying the hyperlink and a Course ID, is also associated with the Pointer ID in that table. Through the tables of associations described above, the resource associated with a Pointer ID or the web address of the resource associated with the Pointer ID may be identified, located and provided to the user.

The use of the indirect reference to each Resource ID through the Pointer ID facilitates modification of the resource associated with an activation point in the GUI 10. For example, if the resource is no longer available (the web page is down) or a better resource is found for that activation point, the Pointer ID associated with the link may be simply associated with the new reference, across all the programs that may allow access to that resource, by changing the Resource ID associated with the Pointer ID in the Resource Link Table. The Pointer ID need not be changed. Use of such indirect referencing, while preferred for ease of content update management, is not required to display the resources.

A resource containing time sensitive information may be assigned an expiration date, which may also be associated with the Resource ID in the Resource Information Table, so that during program creation, obsolete resources will not be used in future programs.

Each PC 216 comprises a processor 218, memory 220, an input device 222, such as a mouse, and a monitor 224. The processor 218 preferably operates at least 166 Megahertz. The processor may be a Pentium I, available from Intel Corporation, for example. 300 Megahertz is preferred, such as in the Pentium II. Random Access Memory (RAM) of at least 32 MB should be available. 64 MB or higher is preferred. The monitor 224 should have a screen resolution of at least about 800×600, and preferably 1024×768. Color of at least 8-bits and preferably 16-bits or higher, is also preferred for proper display of the GUI 10. A 16-bit sound card is also preferably provided. The PC 216 includes a browser, such as Internet Explorer or Netscape Navigator.

The Web Link Checker 214 is a computer that periodically checks the status of every hyperlinked web page to ensure that the page is still active. The check can take place every other day, for example. The Web Link Checker is programmed to retrieve all the web addresses (URLs) stored in the Database 204 of the resources stored on External Servers 214 and to make an appropriate HTTP, HTTPS or FTP request for each one. The header information or the Server Notification of the response is read by the Web Link Checker 214 to determine if the web page is active or not. For example, receipt of a Server Notification 404 indicates that the web page is missing. Server Notification 503 indicates that the web site cannot be contacted. If a web page is down, the organization is notified by e-mail. The organization can then substitute another web page for the down site. Until then, the Status ID in the Resource Information Table for that resource can be changed to indicate that the resource is unavailable. If the user clicks on an activation point to such a resource, a warning is generated by the Application Server 208. The user's browser then opens the warning. The user does not, then, waste time attempting to connect to the site. The hyperlink can also be removed from the text 18 so that the word or phrase is no longer highlighted in the transcript.

Preferably, the results of past checks of each web site are analyzed to determine the degree of inactivity of the site. For example, a web page that is inaccessible 75% of the time or more may be classified as “Dead” and given a high priority for replacement by the organization. A web site that is inaccessible less than 75% of the time may be considered temporarily down and need not be replaced as quickly as a dead site.

In addition, part of each web page accessible through a program is preferably stored on the Application Server 208, preferably as a text (.TXT) file stripped of HTML code. That web page is then available for searching by a user, either through the organization's web page or the GUI 10. This is faster than searching remote web pages in real-time.

The Web Link Checker 214 also preferably compares the actual site to the stored information to determine if the site is the same. If the web page has been changed, the organization is notified by an e-mail. The page may then be checked by the organization to determine if the page is still applicable. The Web Link Checker also preferably scans the content of a web page by string parsing of the text to determine if there is other information on the page. For example, a web page may include a Redirect to another web page. The organization would then be able to check the page to determine if the Redirect is to a relevant web page.

The Video Server 212 stores the video and associated audio files for each program and streams them to the user's PC 216, as is known in the art. Preferably, the Video Server includes a Real Video Server available from RealNetworks and a Windows Media Server, available from Microsoft Corporation, so that users with both types of browsers may be served. The Video Server may be a single Windows NT or Windows 2000 Server including both software servers (Real Video and Windows Media) or two separate servers.

The Database 204 may be an Oracle 7.3.4, available from Oracle Corporation, for example. The Web Server 206 and the Resource Server 210 may be an Internet Information Server (IIS) 4.0, available from Microsoft Corporation, for example. The Web Server and the Resource Server may be on the same or separate servers. The Application Server 208 may be a Cold Fusion 4.5 Server, available from Allaire Corporation, for example. The Web Link Checker 214 may be a Windows NT or Windows 2000 Server running a Visual Basic Application written in VB 6.0, for example.

To view a program, a user accesses the organization's home page to select a program selection. A login procedure, including a usemame and password, may be required. When a program is selected, a web page for the program is displayed. The web page includes a Start Program button. Clicking on the Start Program button invokes a JavaScript function that identifies the browser being used by the user's PC 216. The correct GUI 10 for that browser is then called. A unique Course Acronym for that program is also sent to the Application Server 208 through the Internet. The Application Server requests the program corresponding to the acronym from the Database 204 by passing the acronym to the Database. The Database includes a Table relating the acronym to a Course ID. All resources that relate to a particular program are associated with the Course ID for that program in the Resource Link Table. The Database retrieves a list of resources associated with that program and the Pointer IDs associated with each resource based on the Course ID. Relevant information from the tables, including Table I, the table of glossary terms and the table of presenter information, is also retrieved for each table based on the Course ID.

The retrieved data is reformatted as necessary by the Application Server 208. For example, the information from Table I, the glossary table and the presenter table are preferably reformatted into JavaScript arrays. The names of the resources, such as the web links, key documents, multimedia, video clips, recommended books and related programs are preferably reformatted into HTML lists. The information is then passed to the Web Server 206, which serves this information to the user's PC 216 via the Internet 202, for temporary storage in memory 220 of the user's PC. All resources available to the user or references to those resources are preferably served to the user's PC.

The HTML, CSS and CFML which define the GUI 10 are served from the Application Server 208 to the memory in the user's PC through the Web Server 206, along with the JavaScript functions that control the operation of the GUI. The JavaScript functions are run by the browser of the user's PC, using the processor 218.

Based on the acronym, the path (URL) to the appropriate media file in the Video Server 212 for the selected course is constructed by the Application Server 208. The path is passed to the player on the user's PC 216, which requests the video associated with the path of the selected course from the Video Server through the Internet 202. The Video Server then starts to stream the video for that program to the user's PC, as is known in the art. The streamed video segments are also stored in the memory of the PC.

After the information and code from the Database 204 and Application Server 208 are stored in the memory 220 of the user's PC 216, the GUI 10 is launched on the monitor 224 of the user's PC from the memory, by the browser on the user's PC. The GUI is shown in FIG. 1, as discussed above.

When the user clicks on the Play Tab (not shown) on the GUI, a call is made to the Video Player in the user's PC to start playing the streamed video. A JavaScript function is also invoked to start display of the first page of the text 18. If the user's PC does not already include an appropriate player, one must be obtained.

Subsequent portions of the video are streamed to the memory as the video is displayed. The user can control the buffering time to download, if desired, based on the available memory and bandwidth.

Synchronization of the video and transcript text in accordance with the present invention will now be described.

The information in each column of Table I, above, is reformatted into separate JavaScript arrays by the Application Server 208 prior to being served to the user's PC 216. JavaScript functions relate the information in the arrays to each other to recreate the associations in Table I on the user's PC, to provide the required functions. In the following discussions, client-side processing is accomplished through the use of client-side scripting. JavaScript is the preferred client-side script.

One of the JavaScript functions downloaded to the user's PC is preferably a clock which counts a predetermined time interval, such as every one second. To synchronize the advance of a page of text with the video, the position of the video is checked and the playtime corresponding to the position of the video is preferably compared to both the Cue Start and Cue End times in the JavaScript arrays, to identify the video segment being played. The corresponding transcript page which should be displayed from the Transcript Page array is also identified. When the playtime is at or past the Cue Start time for the next transcript page and prior to the Cue End time for that next transcript page, the next transcript page from Table I is displayed by the browser. While only one of the Cue Start or the Cue End times needs to be checked to synchronize the advance of a transcript page, it is preferred to check both for accuracy.

Other functions may be provided through the JavaScript arrays based on Table I by invoking suitable JavaScript functions, as well.

Entering a page number in the Go To entry field 44 causes the browser to identify the Cue Start time for that page and call the Video Player to go to that Cue Start time. The corresponding transcript page is identified and displayed, as well.

Clicking on the Forward Tab 34 or the Forward Page Tab 44 causes the browser to check the Cue Start time for the page following the current page. The Video Player is then called to go to that Cue Start time and the transcript text for that page is identified and displayed.

Clicking on the Rewind Tab 28 or the Prior Page Tab 42 causes the browser to check the time since the current page has started. If less than a predetermined amount of time has elapsed since the start of the page, such as two seconds, the Cue Start time for the prior page is checked and the Video Player is called to go to that Cue Start time. The corresponding transcript page is identified and displayed, as well. If more than the predetermined period of time has elapsed, the Cue Start time for the current page is identified and the Video Player is called to go to that location. It is not necessary to change the page of the transcript.

The Functions Region 50 includes a Display Region 50a for display of the functions implemented in the Functions Region 50 of the GUI 10, and a Functions Bar 51 including the Functions Tabs 52-62. Preferably, the GUI 10 comprises layers, and in some cases multiple layers, for each function. Each layer is part of the same page and displayed within the same window as the GUI 10.

Each layer comprises information or activation points to information, or both. Until one of the Functions Tabs 52-62 is activated, the Display Region 50a displays a layer including the Functions Bar 51 and a background layer. In the GUI 10, the background layer is preferably black. Other colors may be used, as well. The Display Region 50a is a substantial portion of the Functions Region 50. Preferably, the Display Region is at least 50% of the Functions Region 50. More preferably, the Display Region 50a is at least about 70% of the Functions Region and even more preferably, at least about 80% of the Functions Region. Activating one of the Functions Tabs causes the browser to make visible the appropriate layer of the GUI 10. The use of multiple layers including activation points and information in the GUI 10, enables rapid access to functions, such as the Topics List 64, the Search Function, the Glossary Terms 82 and Definitions 84, Presenter Information and the lists of Web Links, Key Documents, Multimedia Video Clips and related programs, without reloading the GUI 10. It is only necessary to open a new browser window to display information accessed from the Internet, when a particular activation point for a web link, key document, multimedia, video clip or related program resource is activated. Access to a large amount of information is thereby efficiently provided through the GUI 10, without distracting the user. The different layers and the information and activation points displayed in those layers may be rapidly accessed. The program may continue while a Functions Tab is activated and the Functions layers and associated information are displayed.

The video/transcript can also be searched by topic through the data from Table I. Clicking on the Topics Tab 52 causes the GUI layer including the Topics List 64 to be made visible. (See FIG. 2). The user can advance through the list and click on a particular topic. Clicking on a desired topic advances the transcript to the first page of the transcript referring to the selected topic and advances the video to the location corresponding to that page. The Cue Start time for that first occurrence is identified and the Video Player is then called to go to that Cue Start time. The corresponding page of text is then displayed. A topic can also be found through a word search. Providing the Topics List 64 as part of the GUI 10 facilitates synchronization and navigation with respect to the video and text.

It is noted that scroll bars are difficult to define in Netscape Navigator with DIVS. The scroll bars in the GUI 10 for use with Netscape Navigator may be defined instead by graphics and JavaScript functions. Scroll bars may be readily defined in Internet Explorer.

Clicking on the Search Tab 54 makes the Search Layer visible. Entering a search term in the field 72 and clicking on the SEARCH button 74 invokes a search of the JavaScript array corresponding to the Transcript Text column for the entered word or phrase. A list 78 of transcript pages where the search word appears is generated and displayed. The topic from the Topics Column corresponding to the page may also be displayed. When the user clicks on one of the transcript pages, the browser displays the page and the video is moved to the corresponding location. The first appearance of the term may be highlighted on the displayed page.

Accessing of Glossary terms will now be discussed. Glossary terms, their definitions and a Course ID or IDs identifying the programs where a term appears, are stored in a table in the Database. The appropriate entries from the Glossary Table for the selected program are served to the memory 220 of the user's PC 216 in a JavaScript array. The appropriate entries are identified through the Course ID of the selected program.

The Glossary may be accessed by clicking on the Glossary Tab 56 in the Functions Box of the GUI 10 (FIG. 1). The Glossary Layer 80, including a list of defined terms, is made visible. Clicking on a term invokes a JavaScript function which retrieves the definition from the JavaScript array corresponding to the portions of the Glossary Table served to the user's PC, and displays the definition while the video is playing.

The transcript text 18 also includes highlighted, hyperlink terms 48, which are defined in the Glossary. Clicking on a highlighted word or phrase retrieves the definition from the JavaScript array and causes the Glossary Layer 80 to be made visible. The definitions may be quickly reviewed, without disrupting the play of or viewing of the video.

Prior to discussing the other functions accessible in the Functions Box, the transcript text will be discussed.

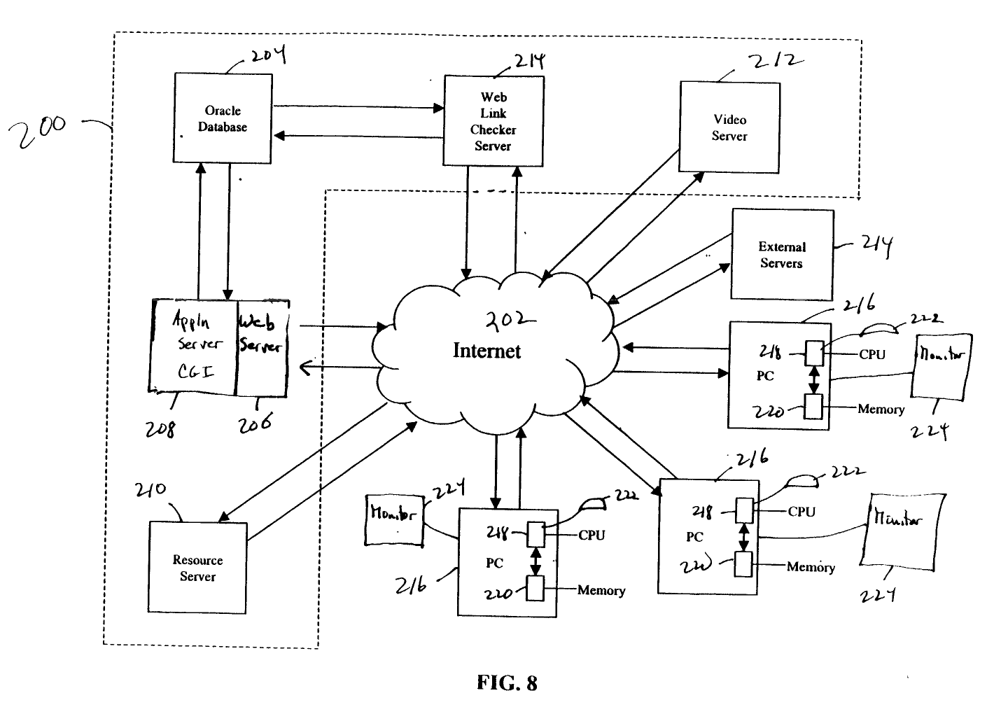

Preferably, the transcript text includes different colored hyperlinks, based on the type of the resource corresponding to the hyperlink. For example, a “blue” link may be a link to resources external to the organization's system, such as web pages not stored on an External Server 214 (See FIG. 8), as is general usage on the Internet. A “red” link may be associated with a resource stored in the organization's system (such as the Web Server 206) in a file format which requires another application, such as Adobe Acrobat, to open. A “green” link opens a resource within the GUI 10 (i.e., stored on the user's PC 216, such as glossary terms). Use of different colors conditions a frequent user to expect the type of resource to be displayed and the events which will occur. Blue was chosen for its function, because of its already accepted usage. Red and green were chosen for their functions for their respective vividness.

Clicking on a blue or red hyperlink in the transcript text invokes a hyper-reference (“href”) including the Pointer ID for that reference. A parameter indicating whether the resource probably may be opened by the browser is preferably associated with the Pointer ID. If the parameter indicates yes (i.e., if the parameter is set to “1”, for example), a new browser window is opened to allow the resource to be displayed. If the parameter indicates no (i.e., if the parameter is set to “0”, for example), the browser checks the type of the resource. A resource in the form of an executable file, for example, may not be able to be opened and could need to be stored in memory 220 of the user's PC 216. The resource may be stored on the hard drive of the user's PC, for example. If the resource may be opened and the browser recognizes the resource, an appropriate application program is opened, if available. For example, if the resource is a PDF file and the user's PC includes Adobe Acrobat Reader, the Reader would be opened to open the resource. If the user's PC does not have the appropriate application, it may be offered through a download from the source of the particular application, such as Adobe Systems, Inc. If the browser cannot identify the type of the resource to be downloaded, then the browser prompts the user to save the file in memory 220, such as on their hard drive, where it can be opened after an appropriate user application is installed.

After the new browser window is opened, another href is invoked by sending an URL including the Pointer ID to the Application Server 208. The URL also includes a .CFM extension, which identifies the Cold Fusion Template that needs to be parsed. The Web Server 206 recognizes the .CFM extension and passes the URL to the Application Server for processing.

The Application Server queries the Database 208 based on the Pointer ID. The current Resource ID, Resource Type and Status ID of the resource are obtained from the Resource Link and Resource Information Tables. If the status of the resource is “down” or “not available” then a warning is sent to the user, as described above.

If the status of the user is “available”, a second query is run by the Application Server to retrieve the information necessary to generate the actual web address (URL) of the resource. If the link is a “red” link to a resource stored on the organization's Web Server 206 or Resource Server 210, the Resource Type associated with the Resource ID in the Resources Information Table will indicate the type of file and thereby the file folder where the resource is stored. The file name of the resource is obtained from the Resource URL Information Table based on the Resource ID, as well. The actual URL including the location of the resource is then generated by the Application Server. For example, if the resource is an article in PDF format with a file name XYZ, the file is stored in a PDF folder of the Resource Server. The URL could then be http://resources.[organizationname]/PDF/XYZ.pdf. The URL is then passed by the Application Server to the browser in the user's PC 216. The browser then invokes an HTTP request to open the web page. Alternatively, the resource itself could be directly sent to the user's PC.

If the link is a “blue” link to a web page stored on an External Server 214, the Resource Type would indicate that status. The web address (URL) is obtained from the Resource URL Information Table, through an association with the Resource ID. The Application Server prepends appropriate information to the web address (URL) to identify the type of transfer protocol (i.e., HTTP//; FTP//; or HTTPS://) necessary to access the web page, based on the Resource Type. The Application Server then passes the completed address to the browser in the user's PC, which invokes an appropriate request (i.e., HTTP, FTP or HTTPS) to open the web page. As discussed above, a word or phrase defined in the Glossary is preferably indicated as a “green” link. Clicking on a green link retrieves the locally stored information for display by the browser.

If the link causes retrieval of a web page, the browser opens a new window superimposed over the GUI 10. The program video continues while the new window displays the web page. After review of the web page, the user can go back to the desired point in the program, such as by using the Go To entry field 44, as discussed above. It is preferred not to stop the video because rebuffering of the video is typically slow. If the user has opened another Video File, however, the program video is stopped because the Video Player cannot play two videos simultaneously.

Returning to the Functions Region 50, clicking on the Web Links Tab 58 makes visible a list of activation points or links to external web pages, as shown in FIG. 5. Clicking on a link invokes a hyper-reference (“href”) including the Pointer ID for that web link. The web address for the web link is then retrieved from the Database 204, as described above with respect to blue and red links in the transcript text.

Clicking on the Presenter Tab 60 makes visible the Presenter's Layer 90 including the Presenter's name and the names of people interviewed during the Program. Each name is an activation point to further information about the person. Clicking on a name retrieves the information, which has preferably been served to the memory of the user's PC in a JavaScript array. An e-mail link may also be provided. Clicking on the e-mail link invokes a hyper-reference (“href”) which opens an e-mail window, via the web server.

As discussed above, the Resources Tab 62 provides links to resources stored by the organization and accessible to the user. Because of the large number of resources, the resources are preferably organized by categories, such as Key Documents 100, Multimedia 102, Video Clips 104, Recommended Books 106 and Related Programs 108. Clicking on the Resources Tab 62 makes visible a Resources Layer 98 including activation points for each category. Clicking on one of the categories causes retrieval from the memory 220 of an advanceable list of available resources under that category which is displayed in the Resources Layer 98. By providing one activation point (the Resources Tab 62) to activation points to categories of resources, activation of which displays a list of the resources, a large number of resources may be made available to the user, without overburdening the appearance of the GUI 10. The user may thereby watch the video and read the text without being distracted by a lot of additional information.

Clicking on an activation point to resources stored on the Resource Server 210 or the Web Server 206, such as the Key Documents 100, Multimedia 102 and Video Clips 104, invokes a hyper-reference (“href”) including the Pointer ID for that reference, as described above with respect to red links in the transcript. A new browser window is opened to display the resource over the video and text.

Recommended Books are also stored in a table on the Database, along with Pointer IDs to references to URLs for web pages of on-line bookstores, such as Amazon.com and Fatbrain.com. Clicking on the Recommended Books Tab 106 causes the browser to make visible an advanceable list of the books. Clicking on one of the books invokes an href including the Pointer ID for the web page from the on-line bookstore corresponding to that book. The URL for that web page is constructed, as described above with respect to blue links in the transcript, and returned to the user's PC. The browser opens a window to display the page.

A list of Related Programs is also stored in a table in the Database and served to the user's PC. Clicking on the Related Programs Tab 108 causes display of the list by the browser. A list of related programs appears. Clicking on one of the programs causes display of the web page of the program, discussed above.

The Pre- and PostTests are accessible through the menu bar 112 by clicking on Test 116. (See FIG. 1). The tests may be realized through the use of tables of associated questions and answers, which would be reformatted and served to the memory of the user's PC 216. The transcript text page number where the answer to the question may be found, is also preferably associated with the answers to each question. The page number may be an activation point to go to that page, by a JavaScript function, for example.

Clicking on Contact 118 in the menu bar 112 displays a custom e-mail link directly to the organization or a relevant department of the organization. A hyper-reference (href) is invoked which opens an e-mail window, via the Web Server.

A link for a survey may also be provided in a drop down menu under Contact 118, for example. The relational Database 208 may store a variable number of questions that can be displayed dynamically, for the purpose of providing the survey of the user.

The GUI 10 and the system 200 may be readily adapted to provide additional information, such as vendor information on relevant products.

We claim:

1. A method of presenting a program on a user's computer, the program being provided through the Internet, the method comprising:
displaying a video downloaded to the computer from the Internet;
displaying a page of text corresponding to the video, the page of text being downloaded to the computer from the Internet; and
advancing the text page by page, in synchronization with the video.

2. The method of claim 1, wherein the video includes spoken words and the text comprises text of the spoken words.

3. The method of claim 2, further comprising:
accessing additional information related to the program through the computer; and
displaying the accessed information while displaying the video and the text.

4. The method of claim 3, comprising accessing and displaying web pages.

5. The method of claim 4, wherein references to web addresses of accessible web pages are downloaded from the Internet to the computer prior to displaying the video and text.

6. The method of claim 4, comprising accessing and displaying a requested web page chosen from the group consisting of documents, multimedia presentations, video clips and related programs.

7. The method of claim 4, further comprising displaying additional information stored on the computer's memory, downloaded from the Internet prior to displaying the video and the text.

8. The method of claim 7, comprising displaying a definition of a term.

9. The method of claim 6, comprising displaying requested information chosen from the group consisting of recommended books and presenter information.

10. The method of claim 3, comprising providing access to information by keyword searching.

11. The method of claim 10, comprising providing access to particular locations in the text by keyword searching.

12. The method of claim 3, comprising accessing the selected information through client side scripting.

13. The method of claim 1, further comprising providing user control of the page of text and the video.

14. The method of claim 1, further comprising displaying a list of topics of the program.

15. The method of claim 1, comprising streaming the video to the computer.

16. The method of claim 1, comprising providing hypertext links to additional information, in the text.

17. A method of presenting a program provided to a user's computer through the Internet by an organization, comprising:
(1) displaying a video downloaded to a computer from the Internet;
(2) displaying text corresponding to the video, the text being downloaded to the computer from the Internet;
(3) providing access to web pages of the organization;
(4) providing access to other web pages;
(5) providing access to additional information; and
(6) displaying the selected additional information while the video and text are displayed.

18. The method of claim 17, comprising displaying the video and the text in adjacent regions and displaying the selected additional information in a region below the video and the text.

19. The method of claim 17, comprising controlling steps (1)-(6) through client side scripting.

20. A method of checking the status of web pages accessible through an organization, comprising:
storing web addresses;
periodically requesting at least one of the stored web addresses;
transmitting at least one of the stored web addresses over the Internet; and
evaluating the response to the transmittal of the web address.

21. The method of claim 20, further comprising transmitting the web address a plurality of times and classifying the web page corresponding to the web address based on the evaluation of a plurality of responses.

22. The method of claim 21, wherein, if a web page associated with a web address is not accessible a predetermined percentage of time, associating with that web address an unavailability indication.

23. A method of providing a program to a user's computer, through the Internet, the method comprising:
serving video to the user's computer, through the Internet;
serving text corresponding to the video to the user's computer, through the Internet; and
serving client side scripting to the user's computer, for simultaneously displaying a page of text corresponding to the displayed video and for advancing the text page by page, in synchronization with the video, the client side scripting being provided through the Internet.

24. The method of claim 23, comprising serving text including hyperlinks to additional information.

25. The method of claim 23, further comprising serving code for defining a graphical user interface to the user's computer, the graphical user interface defining a region for displaying the video, a region for displaying the text and a functions region for displaying activation points to additional functions, while displaying the video and the text.

26. The method of claim 23, comprising streaming the video to the user's computer.

27. The method of claim 25, wherein the graphical user interface further defines activation points to the additional functions, the activation points being displayed while displaying the video and the text.

28. The method of claim 27, further comprising serving client side scripting for displaying a function upon selection of an activation point in the functions region, while displaying the video and the text.

29. The method of claim 27, comprising displaying the video and text in adjacent portions of the monitor and displaying the activation points for the functions below the video and text.

30. The method of claim 29, further comprising displaying a selected function in the functions region upon activation of an activation point.

31. The method of claim 30, wherein the additional functions are chosen from the group consisting of a list of the topics of the program, a keyword search window, a list of defined terms, a list of web links, presenter information and a list of other available information.

32. The method of claim 27, wherein one of the functions is a list of topics of the program and each entry in the list is an activation point to the video and text, the method comprising serving data corresponding to the list to the user's computer prior to displaying the video and the text and serving client side scripting for advancing the text and the video to a location corresponding to a selected topic, upon activation of an activation point.

33. The method of claim 27, wherein one of the functions is a keyword search window for entry of a term, the method further comprising serving client side scripting for searching the text and displaying a list of text locations where the search term appears.

34. The method of claim 27, wherein one of the functions is a list of defined terms and each entry in the list is an activation point to a definition of the term, the method further comprising serving data corresponding to the list of defined terms and the definitions of the defined terms to the user's computer prior to display of the video and serving client side scripting for displaying the definition of a selected term to the user's computer.

35. A method of providing a program through the Internet, comprising:
serving video to a user's computer, through the Internet;
serving text corresponding to the video to the user's computer, through the Internet;
serving client side scripting to the user's computer for simultaneously displaying a page of text corresponding to the displayed video and for advancing the text page by page, in synchronization with the video through the Internet;
serving additional information to the user's computer, for selective display through the Internet; and
serving references to web pages to the user's computer, wherein the web pages may be selectively displayed by the user.

36. A graphical user interface between an organization providing a presentation via the Internet and a user's monitor, the graphical user interface comprising:
a region for displaying a video of a presentation; and
a region for displaying pages of text corresponding to the video, page by page, in synchronization with the video.

37. The graphical user interface of claim 36, further comprising an activation point for accessing additional information.

38. The graphical user interface of claim 37, wherein activating the activation point causes display of at least one additional activation point.

39. The graphical user interface of claim 38, wherein activation of the at least one additional activation point causes display of at least one second additional activation point.

40. The graphical user interface of claim 39, wherein activation points are in separate layers of the interface and activation of one activation point makes visible a layer including at least one other activation point.

41. The graphical user interface of claim 37, wherein the additional information is accessed and displayed during display of the video and text.

42. The graphical user interface of claim 36, further comprising an activation point for accessing information stored by the organization, through the Internet.

43. The graphical user interface of claim 42, wherein the activation point provides access to information in a form chosen from the group consisting of a document, a multimedia presentation, a video clip, and a related program.

44. The graphical user interface of claim 42, further comprising an activation point for accessing information stored on the user's computer.

45. The graphical user interface of claim 44, wherein the activation point provides access to a definition of a word or phrase.

46. The graphical user interface of claim 36, further comprising an activation point for accessing information stored on the user's computer.

47. The graphical user interface of claim 46, wherein the activation point provides access to a definition of a word or phrase.

48. The graphical user interface of claim 37, wherein the activation point provides access to a web page.

49. The graphical user interface of claim 48, wherein activation of the activation point causes a reference to a web page to be provided to a server.

50. The graphical user interface of claim 37, wherein the at least one activation point is a highlighted text string in the text.

51. The graphical user interface of claim 37, wherein the activation point provides access to information by searching a term.

52. The method of claim 51, wherein the search results comprise at least one activation point, activation of which causes advance of the transcript text to a page including the search results and the advance of the video to a location corresponding to the page of text.

53. The graphical user interface of claim 36, further comprising an activation point for causing display of a list of topics of the program, wherein each topic is an activation point, activation of which causes advance of the transcript text to a page including the topic and advance of the video to a location corresponding to the page of text.

54. The graphical user interface of claim 53, wherein the list of topics is stored on the user's computer.

55. The graphical user interface of claim 36, wherein the video region is for displaying streaming video.

56. Software executable to generate a graphical user interface between an organization providing a program via the Internet and a user's monitor, the graphical user interface comprising:
a region for displaying a video of a program; and
a region for displaying text of the video, page by page in synchronization with the video.

57. The software of claim 56, executable to generate a graphical user interface further comprising an activation point for accessing additional information.

58. A server programmed to serve a graphical user interface between an organization providing a program via the Internet and a user's computer, the graphical user interface comprising:
a region for displaying a video of a presentation; and
a region for displaying pages of text corresponding to the video, in synchronization with the video, page by page.

59. The server of claim 58, further programmed to serve a graphical user interface comprising an activation point to additional information.

60. The server of claim 59, further programmed to serve data corresponding to the additional information, to the user's computer, prior to display of the video and the text.

61. The server of claim 60, further programmed to serve client side scripting to the user's computer for controlling operation of the graphical user interface.

62. A system for presenting a selected one of a plurality of programs via the Internet to a user via a computer, the program comprising a video, a text corresponding to the video and access to additional information, the system comprising:
a database storing identifying information for a first set of information available to the user in the plurality of programs and a second set of information available to the user in the plurality of programs, the first and second sets of information being stored in tables comprising information for the plurality of programs;
a video server for serving the video to the user's computer; and
a server programmed to serve code for defining a graphical user interface on the user's computer, the graphical user interface comprising a region for displaying the video and a region for displaying the text corresponding to the video, the server being programmed to request information from the database comprising portions of the first and second sets of information related to the selected program and serving said information to the user's computer through the Internet, prior to presentation of the program;
wherein the database retrieves the requested information for the selected program from the tables.

63. The system of claim 62, wherein the server is further programmed to serve a graphical user interface comprising an activation point to additional information.

64. The system of claim 63, further programmed to serve client side scripting to the user's computer for controlling operation of the graphical user interface.

65. The system of claim 64, wherein the text is served to the user's computer prior to start of the program and the text is advanced page by page in synchronization with the video, under the control of the client side scripting.

66. The system of claim 62, further comprising a server for checking the status of the web pages.

67. A computer comprising a processor and memory, the processor being programmed to display a presentation from the Internet by:
generating a graphical user interface comprising:
a region for displaying a video of a presentation; and
a region for displaying pages of text corresponding to the video, page by page, in synchronization with the video.

68. The computer of claim 67, further programmed to generate a graphical user interface further comprising an activation point to additional information.

69. The computer of claim 68, wherein the additional information is accessible through the Internet upon activation of the activation point.

70. The computer of claim 68, wherein the memory comprises data corresponding to the at least a portion of the video, data corresponding to the text and data corresponding to additional information are stored in the memory.

71. A graphical user interface, comprising:
a first region for displaying video of a presentation;
a second region for displaying text corresponding to the video; and
a third region comprising a display portion for selectively displaying at least one additional function, and at least one activation point, wherein activation of the activation point causes display of the at least one function in the display portion, the function is hidden until the activation point is activated, and the display portion is a substantial portion of the third region.

72. The graphical user interface of claim 71, comprising a plurality of activation points, activation of a selected one of the activation points causing display of a respective function in the display portion.

73. The graphical user interface of claim 72, wherein the plurality of activation points are arranged in a row at the bottom of the third region.

74. The graphical user interface of claim 71, wherein the display portion is at least about 80% of the third region.

75. The graphical user interface of claim 71, wherein the first and second regions are adjacent to each other.

76. The graphical user interface of claim 71, wherein the third region is below the first and second regions.

77. The graphical user interface of claim 71, wherein the displayed function comprises additional activation points to additional information, each activation point corresponding to a type of information.

78. The graphical user interface of claim 77, wherein the types of information are chosen from the group consisting of documents, multimedia, video clips, recommended books and related programs.

79. The graphical user interface of claim 77, wherein the additional information comprises a list of activation points, each activation point corresponding to an item of information, and activation of an activation point causes display of the corresponding item of information in the display portion.

80. The graphical user interface of claim 77, wherein the additional information comprises a list of activation points, each activation point corresponds to an item of information and activation of an activation point causes display of the corresponding item of information in a new browser window.

81. The graphical user interface of claim 71, wherein the displayed function is a list of activation points.

82. The graphical user interface of claim 81, wherein the list is chosen from the group consisting of topics of the presentation, defined terms, web links and presenter information.

83. The graphical user interface of claim 71, wherein the displayed function is a keyword search.

84. The graphical user interface of claim 72, wherein the interface comprises at least one layer corresponding to a respective function, and activation of a respective activation point makes visible the layer in the display portion.

85. The graphical user interface of claim 71, wherein the function is displayed while the video and text are being displayed.
